(19) United States
(12) Patent Application Publication
(10) Pub. No.: US 2014/0212746 A1
(43) Pub. Date: Jul. 31, 2014

(54) LITHIUM SECONDARY BATTERY FOR HIGH VOLTAGE

(71) Applicant: SAMSUNG SDI CO., LTD., Yongin-si (KR)

(72) Inventor: Daesik KIM, Yongin-si (KR)

(73) Assignee: SAMSUNG SDI CO., LTD., Yongin-si (KR)

(21) Appl. No.: 14/107,099

(22) Filed: Dec. 16, 2013

(30) Foreign Application Priority Data
Jan. 25, 2013 (KR) 10-2013-0008871

(51) Int. Cl. H01M 10/0567; H01M 10/052

(52) U.S. Cl. CPC H01M 10/0567; H01M 10/052
USPC 429/188

(57) ABSTRACT

A lithium secondary battery for producing a high voltage, the lithium secondary battery including a negative electrode; a cyclic polyamine compound as an additive; and a positive electrode including a high-voltage spinel-type positive active material represented by Formula 1:

Li₁₊ₓNi_{y}Mn_{2-y-z}M_{z}O_{4+w} (1)

wherein, in Formula 1, 0≦x<0.2, 0.4≦y≦0.6, 0≦z≦0.2, 0≦w≦0.1, and M is at least one element selected from the group of Al, Ti, Mg, Zn, Mo, Y, Zr and Ca.

### CROSS-REFERENCE TO RELATED APPLICATION

Korean Patent Application No. 10-2013-0008871 filed on Jan. 25, 2013, in the Korean Intellectual Property Office, and entitled: “LITHIUM SECONDARY BATTERY FOR HIGH VOLTAGE,” is incorporated by reference herein in its entirety.

### BACKGROUND

1. Field

Embodiments relate to a lithium secondary battery for a high voltage.

2. Description of the Related Art

Extended application fields of lithium secondary batteries, ranging from power sources of small-sized electronic devices to power sources of electric vehicles, etc., have led to increasing demands for positive electrode materials for secondary batteries having a high level of safety, long lifetime, high energy density, and high output characteristics.

### SUMMARY

Embodiments are directed to a lithium secondary battery for a high voltage.

The embodiments may be realized by providing a lithium secondary battery for producing a high voltage, the lithium secondary battery including a negative electrode; a cyclic polyamine compound as an additive; and a positive electrode including a high-voltage spinel-type positive active material represented by Formula 1:

Li₁₊ₓNi_{y}Mn_{2-y-z}M_{z}O_{4+w} (1)

wherein, in Formula 1, 0≦x<0.2, 0.4≦y≦0.6, 0≦z≦0.2, 0≦w≦0.1, and M is at least one element selected from the group of Al, Ti, Mg, Zn, Mo, Y, Zr and Ca.

The cyclic polyamine compound may include at least one selected from the group of 1,4,8,11-tetraazacyclotetradecane (cyclam), 1,4,7,10-tetraazacyclododecane (cyclene), 1,4,8,11-tetramethyl-1,4,8,11-tetraazacyclotetradecane (TM-cyclam), 1,4,8,11-tetraazacyclotetradecane-5,7-dione (DO-cyclam), and cyclo(β-alanylglycyl-β-alanylglycyl).

The cyclic polyamine compound may be in an electrolyte solution.

The cyclic polyamine compound may be included in an amount of about 0.01 wt % to about 1 wt %, based on a total weight of the electrolyte solution.

The positive electrode may further include one or more inorganic additive selected from the group of ZnO, TiO₂, SnO₂, Al₂O₃, In₂O₃, SiO₂, WO₃, and V₂O₅.

An operating voltage of the positive electrode may be about 4.6 V or higher, based on lithium metal.

The compound represented by Formula 1 may be LiMn_{1.5}Ni_{0.5}O₄.

The cyclic polyamine compound may include 3 or more nitrogen atoms in a ring of the compound.

The cyclic polyamine compound may include about 4 to about 8 nitrogen atoms in the ring of the compound.

The polyamine compound may further include at least one pendant hydrocarbon group bound to at least one of the nitrogen atoms in the ring of the compound.

### BRIEF DESCRIPTION OF THE DRAWINGS

Features will become apparent to those of skill in the art by describing in detail exemplary embodiments with reference to the attached drawings in which:

FIG. 1 illustrates a schematic diagram of an additive acting in a lithium secondary battery according to an embodiment;

FIG. 2 illustrates a schematic diagram showing an additive according to an embodiment trapping manganese ions;

FIG. 3 illustrates a graph showing a difference in battery performance according to use or non-use of an additive at a 4.8 V charged state;

FIG. 4 illustrates a graph showing a difference in battery performance according to use or non-use of an additive at a 4.2 V charged state; and

FIG. 5 illustrates a schematic cross-sectional view of a lithium secondary battery for a high voltage according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

The embodiments relate to a lithium secondary battery for a high voltage, e.g., for producing a high voltage. The lithium secondary battery may include a negative electrode, a cyclic polyamine compound as an additive, and a positive electrode including a high-voltage spinel-type positive active material represented by Formula 1:

Liᵢ₊ₓNi_{y}Mn_{2-y-z}M_{z}O_{4+w} (1)

In Formula 1, x, y, z, and w may satisfy the following relations: 0≦x<0.2, 0.4≦y≦0.6, 0≦z≦0.2, 0.23 w≦0.1. M may be or include at least one element selected from the group of Al, Ti, Mg, Zn, Mo, Y, Zr, and Ca. In the cyclic polyamine compound additive, a number of nitrogen atoms may be about 4 to about 6.

<Cyclic Polyamine>

The spinel-type active material represented by Formula (1) is a suitable battery material that may be used to provide high-output, high-voltage, and low-cost batteries. In order to make use of the spinel-type active material as a battery material, a spinel-type active material and an electrolyte system operable at a high voltage range of approximately 5V should be provided. For example, the spinel-type active material should help reduce and/or prevent Mn elution at a high temperature, which may otherwise occur when using the spinel-type active material.

When the battery or battery system using the high-voltage spinel-type positive active material is maintained at a high temperature state for a constant or extended time, HF may be generated due to decomposition of a lithium salt of LiPF₆ (LiPF₆→LiF+PF₅, PF₅+H₂O→2HF+OPF₃), so that Mn ions (Mn²⁺) in the positive electrode may be eluted, and the generated Mn²⁺ ions may move to the negative electrode. The negative electrode may accept electrons to be precipitated on a surface of the negative electrode. When the high temperature state is sustained, Mn elution and precipitation on the negative electrode may continuously occur, thereby increasing the potential of the negative electrode and resulting in a disruption of cell balance and lowering the capacity.

Accordingly, the lithium secondary battery according to an embodiment may include a cyclic polyamine compound as an additive (e.g., in an electrolyte of the battery) for facilitating use of a high-voltage spinel-type active material.

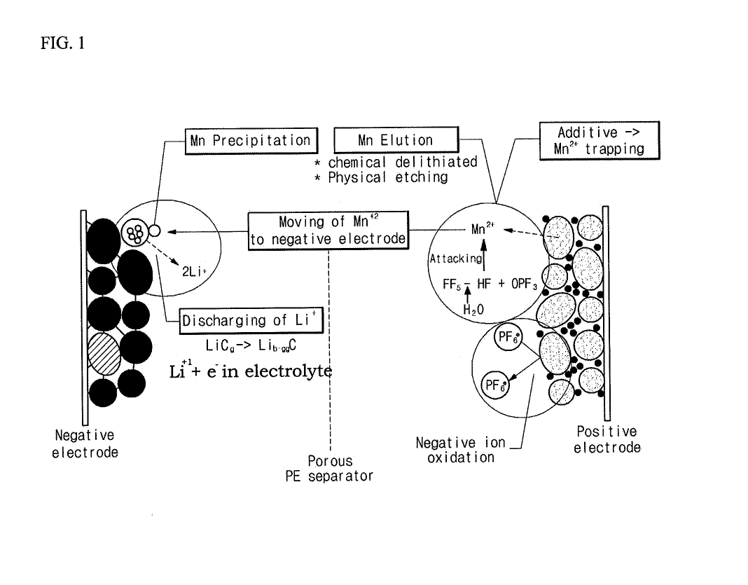

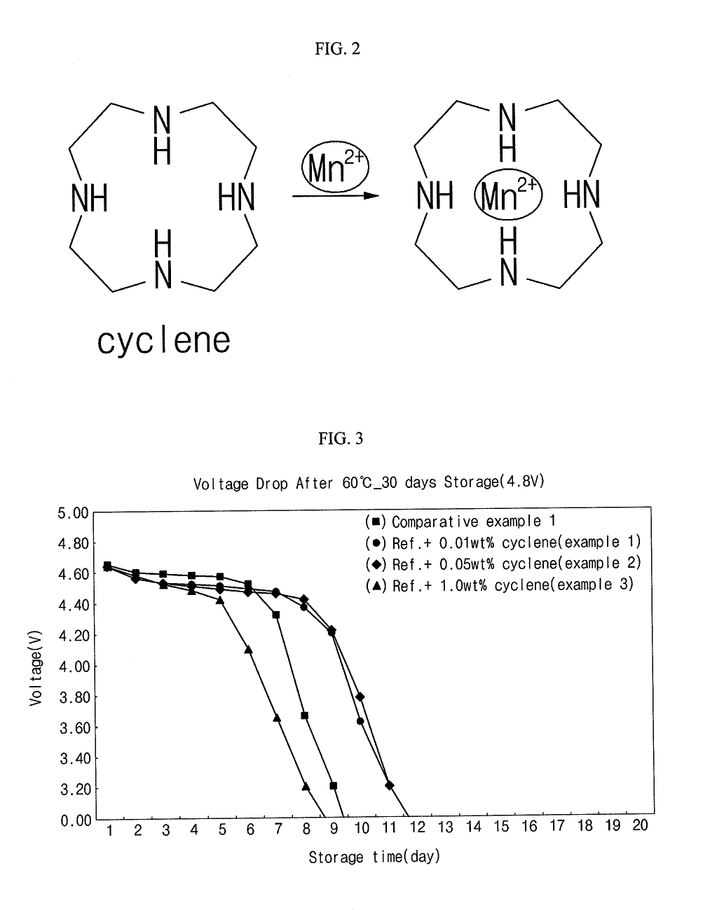

In a battery system of the lithium secondary battery, the cyclic polyamine compound additive may trap manganese during Mn elution, thereby reducing and/or preventing precipitation of Mn from or at the negative electrode (See FIGS. 1 and 2).

When a battery employing the high-voltage spinel-type active material is stored at a high temperature, metal ions, e.g., Mn ions, may be eluted and precipitated on the surface of the negative electrode, thereby increasing the potential of the negative electrode. The cyclic polyamine compound additive may trap Mn to help suppress precipitation of Mn ions, thereby improving a high-temperature storage characteristic, e.g., preventing the OCV from lowering during high-temperature storage (See FIGS. 1 and 2).

The cyclic polyamine may include amine-condensed cyclic compounds and derivatives thereof. For example, the cyclic polyamine may be a cyclic compound having a plurality of nitrogen atoms bonded with alkylene groups. In an implementation, hydrogen atoms bonded with the nitrogen atoms may be substituted with hydrocarbon groups.

The number of nitrogen atoms forming a cycle, e.g., in a ring of the cyclic polyamine, may be 3 or greater, e.g., about 4 to about 8 or about 4. Maintaining the number of nitrogen atoms in the ring at 3 or greater may help facilitate trapping of Mn ions. Maintaining the number of nitrogen atoms in the ring at a sufficiently low number, e.g., about 8 or less, may help prevent trapping holes from being enlarged, thereby ensuring good Mn trapping efficiency.

Examples of the alkylene group may include C2-C4 alkylene groups, such as an ethylene group, a methylethylene group, a propylene group, and a butylene group. In an implementation, the alkylene group may be an ethylene group.

Examples of the hydrocarbon group for substituting hydrogen atoms bonded with nitrogen atoms may include an alkyl group, an aryl group, and an aralkyl group. In an implementation, the hydrocarbon group may be, e.g., an alkyl group. Examples of the alkyl group may include a methyl group, an ethyl group, a propyl group, an isopropyl group, and a butyl group. Examples of the aryl group may include a phenyl group, a dimethylphenyl group, and an ethylphenyl group. Examples of the aralkyl group may include a benzyl group.

Examples of the cyclic polyamine compound may include triazacycloalkanes, such as 1,4,7-triazacyclononane, 1,4,7-triazacyclodecane, 1,4,8-triazacycloundecane, 1,5,9-triazacyclododecane, or 1,6,11-triazacyclopentadecane; tetraazacycloalkanes, such as 1,4,7,10-tetraazacyclododecane (cyclene), 1,4,7,10-tetraazacyclotridecane, 1,4,7,11-tetraazacyclotetradecane, 1,4,8,11-tetraazacyclotetradecane (cyclam), 1,4,8,12-tetraazacyclopentadecane, or 1,5,9,13-tetraazacyclohexadecane; pentaazacycloalkanes, such as 1,4,7,10,13-pentaazacyclopentadecane, or 1,4,7,10,13-pentaazacyclohexadecane; hexaazacycloalkanes, such as 1,4,7,10,13,16-hexaazacyclooctadecane (hexacyclene), or 1,4,7,10,13,16-hexaazacyclononadecane; hydrocarbon substituted triazacycloalkanes, such as 1,4,7-tetramethyl-1,4,7-triazacyclononane, 2,5,8-tetramethyl-1,4,7-triazacyclononane, 1,4,7-tetraethyl-1,4,7-triazacyclononane, 1,4,7-tetraphenyl-1,4,7-triazacyclononane, 1,4,7-tetrabenzyl-1,4,7-triazacyclononane, 1,5,9-tetramethyl-1,5,9-triazacyclododecane, 1,5,9-tetraethyl-1,5,9-triazacyclododecane, 1,5,9-tetraphenyl-1,5,9-triazacyclododecane, or 1,5,9-tetrabenzyl-1,5,9-triazacyclododecane; hydrocarbon substituted tetraazacycloalkanes, such as 1,4,7,10-tetramethyl-1,4,7,10-tetraazacyclododecane, 2,5,8,11-tetramethyl-1,4,7,10-tetraazacyclododecane, 1,4,7,10-tetramethyl-1,4,7,10-tetraazacyclododecane, 1,4,7,10-tetraethyl-1,4,7,10-tetraazacyclododecane, 1,4,7,10-tetraphenyl-1,4,7,10-tetraazacyclododecane, 1,4,7,10-tetrabenzyl-1,4,7,10-tetraazacyclododecane, 1,4,8,11-tetramethyl-1,4,8,11-tetraazacyclotetradecane, 1,4,8,11-tetraethyl-1,4,8,11-tetraazacyclotetradecane, 1,4,8,11-tetraphenyl-1,4,8,11-tetraazaciclotetradecane, 1,4,8,11-tetrabenzyl-1,4,8,11-tetraazacyclotetradecane, 1,4,8,12-tetramethyl-1,4,8,12-tetraazacyclopentadecane, 1,4,8,12-tetraethyl-1,4,8,12-tetraazacyclopentadecane, 1,4,8,12-tetraphenyl-1,4,8,12-tetraazacyclopentadecane, or 1,4,8,12-tetrabenzyl-1,4,8,12-tetraazacyclopentadecane; and hydrocarbon substituted hexaazacycloalkanes, such as 1,4,7,10,13,16-hexamethyl-1,4,7,10,13,16-hexaazacyclooctadecane, 1,4,7,10,13,16-hexaethyl-1,4,7,10,13,16-hexaazacyclooctadecane, 1,4,7,10,13,16-hexaphenyl-1,4,7,10,13,16-hexaazacyclooctadecane, or 1,4,7,10,13,16-hexabenzyl-1,4,7,10,13,16-hexaazacyclooctadecane.

In an implementation, examples of the cyclic polyamine compound may include tetraazacycloalkanes, such as 1,4,7,10-tetraazacyclododecane (cyclene), 1,4,7,10-tetraazacyclotridecane, 1,4,7,11-tetraazacyclotetradecane, 1,4,8,11-tetraazacyclotetradecane (cyclam), 1,4,8,12-tetraazacyclopentadecane, or 1,5,9,13-tetraazacyclohexadecane; and pentaazacycloalkanes, such as 1,4,7,10,13-pentaazacyclopentadecane, or 1,4,7,10,13-pentaazacyclohexadecane.

The cyclic polyamine compound may be used alone or in mixture of two or more thereof.

The cyclic polyamine compound may be used or included in an amount of about 0.01 wt % to about 1 wt %, based on a total weight of a nonaqueous electrolyte solution of the lithium secondary battery. Maintaining the amount of the cyclic polyamine compound within the range stated above may help prevent a reduction in high-temperature (60° C.) storage effect.

<Positive Electrode>

The positive electrode according to an embodiment may be prepared from an electrode composition or slurry, e.g., a positive electrode composition or slurry, which includes a manganese-containing positive active material represented by Formula 1, below, a binder, and a solvent.

Li₁₊ₓNi_{y}Mn_{2-y-z}M_{z}O_{4+w} (1)

In Formula 1, x, y, z, and w may satisfy the following relations: 0≦x<0.2, 0.4≦y≦0.6, 0≦z≦0.2, 0≦w≦0.1. In Formula 1, M may be or include at least one element selected from the group of Al, Ti, Mg, Zn, Mo, Y, Zr, and Ca. In an implementation, the positive electrode composition may further include, e.g., a conducting agent, a filler, and/or a viscosity controlling agent. In an implementation, the positive electrode may further include an inorganic additive.

The binder may include a suitable material that facilitates binding between the positive electrode active material particles, or binding of the positive electrode active material to the current collector. Examples of the binder may include polymers including polyvinylalcohol, carboxymethylcellulose, hydroxypropylcellulose, polyvinylchloride, carboxylated polyvinylchloride, polyvinylfluoride, and ethylene oxide, polyvinylpyrrolidone, polyurethane, polytetrafluoroethylene, polyvinylidene fluoride, polyethylene, polypropylene, styrene-butadiene rubber (SBR), acrylated SBR, epoxy resins, and nylon. In an implementation, the binder may include polyvinylidene fluoride.

A nonaqueous solvent or an aqueous solvent may be used as the solvent. Examples of the nonaqueous solvent may include N-methyl-2-pyrrolidone (NMP), dimethylformamide, dimethylacetamide, N,N-dimethylaminopropylamine, ethyleneoxide, and tetrahydrofuran.

The conducting agent may include a material that has a suitable conductivity without causing chemical changes in the battery that is to be formed. The conducting agent may be included in an amount of about 1 to about 30 wt %, based on a total weight of the electrode composition. Examples of the conducting agent may include a carbon-based material, such as natural graphite, artificial graphite, carbon black, acetylene black, ketjen black, or carbon fiber, a metal-based material, such as copper, nickel, aluminum, silver, or the like, a conductive polymer, such as polyphenylene derivatives, or a conducting material including mixtures of these materials.

The filler is an auxiliary component for suppressing swelling of an electrode, may include a suitable material that is, e.g., a fibrous material, while not causing chemical changes in the battery that is to be formed. Examples of the filler may include olefin based polymers, such as polyethylene or polypropylene, or a fibrous material such as glass fiber or carbon fiber.

The viscosity controlling agent may help control the viscosity of electrode composition to facilitate mixing of the electrode composition and coating of the electrode composition on a current collector. The viscosity controlling agent may be included in an amount of up to about 30 wt %, based on a total weight of the electrode composition. Examples of the viscosity controlling agent may include carboxymethylcellulose and polyvinylidene fluoride. In an implementation, the solvent used in preparing the positive electrode composition may also serve as the viscosity controlling agent.

The inorganic additive may function as an acid in the presence of hydroxide ion (OH⁻), thereby neutralizing the hydroxide ion (OH⁻) and lowering a pH level. A suitable material that can help to prevent gellation of the positive electrode composition may be used as the inorganic additive.

For example, a vanadium oxide (V₂O₅) reaction may take place as follows:

1) Under acidic conditions

V₂O₅+2HNO₃→2VO₂(NO₃)+H₂O

2) Under basic conditions

V₂O₅+6LiOH→2Li₃VO₄+3H₂O

Under basic conditions, vanadium oxide (V₂O₅) may serve as an acid, thereby lowering the pH level.

According to an embodiment, the inorganic additive may be one or more material selected from the group of ZnO, TiO₂, SnO₂, Al₂O₃, In₂O₃, SiO₂, WO₃, and V₂O₅. In an implementation, the inorganic additive may include V₂O₅.

The inorganic additive may be included in an amount of about 0.01 wt % to about 5 wt %, based on the total weight of the electrode composition. Maintaining the amount of the inorganic additive at about 0.01 wt % or greater may help ensure a sufficient gellation preventing effect. Maintaining the amount of the inorganic additive at about 5 wt % or less may help prevent a reduction in discharge capacity, thereby preventing a deterioration of battery characteristics.

The electrode composition may be prepared by dispersing the Mn-containing positive active material, the binder, the inorganic additive, and/or the conducting agent in a solvent, coating the composition on a positive electrode current collector, followed by drying and rolling, thereby fabricating the positive electrode.

Examples of the positive electrode current collector may include a metal, such as aluminum, copper, nickel, silver, or stainless steel, and alloys of these metals. In an implementation, aluminum or an aluminum alloy may be used as the positive electrode current collector. The positive electrode current collector may have a thickness of about 3 to about 500 μm.

<Lithium Secondary Battery>

The embodiments provide a lithium secondary battery including a positive electrode (according to the embodiment described above); a negative electrode (including a negative active material capable of intercalating and deintercalating lithium ions); a separator interposed between the positive electrode and the negative electrode; and an electrolyte.

The negative electrode may include a negative active material capable of intercalating and deintercalating lithium ions. The negative electrode may be fabricated by preparing a slurry composition by dispersing the negative active material, a binder, and/or a conducting agent in a solvent, and coating the slurry composition on a negative electrode current collector.

The negative active material may include one or more selected from the group of a material reversibly intercalating or deintercalating lithium, a metal alloyable with lithium, and mixtures thereof. Examples of the material reversibly intercalating or deintercalating lithium may include at least one selected from the group of artificial graphite, natural graphite, graphitized carbon fiber, graphitized mesocarbon microbead, fullerene and amorphous carbon. Examples of the amorphous carbon may include hard carbon, cokes, and MCMB (Mesophase Carbon Micro Beads) or MPCF (Mesophase pitch based carbon fiber) sintered at 1,500° C. or below. Examples of the metal alloyable with lithium may include at least one selected from the group of Al, Si, Sn, Pb, Zn, Bi, In, Mg, Ga, Cd, and Ge. The metal may be used alone, in mixture or alloys thereof. In an implementation, the metal may be used as a compound mixed with a carbon-based material.

A negative electrode slurry, prepared by mixing and dispersing a negative electrode composition in a solvent, may be coated on a negative electrode current collector, followed by drying and rolling, thereby fabricating the negative electrode.

A nonaqueous solvent or an aqueous solvent may be used as the solvent. Examples of the nonaqueous solvent may include N-methyl-2-pyrrolidone (NMP), dimethylformamide, dimethylacetamide, N,N-dimethylaminopropylamine, ethyleneoxide, and tetrahydrofuran.

Examples of the negative electrode current collector may include a punching metal, an X-punching metal, a gold foil, a metal foam, a net metal fiber sinter, a nickel foil, and a copper foil.

The same materials as those of the positive active material slurry, described above, may be used as the binder and the conducting agent of the negative active material slurry.

The separator may prevent an electric short between the positive electrode and the negative electrode and may provide a movement path of lithium ions. The separator may be a single- or multi-layer separator used for a lithium secondary battery. The separator may include, e.g., polyolefin-based polymer layer, such as polypropylene, polyethylene, polyethylene/polypropylene, polyethylene/polypropylene/polyethylene, or polypropylene/polyethylene/polypropylene, or known materials, such as a microporous film, woven fabric or nonwoven fabric. In an implementation, the separator may include a film prepared by coating a highly stable resin on porous polyolefin film. When a solid electrolyte, e.g., a polymer, is used, it may function as the separator.

The electrolyte may include a lithium salt and a nonaqueous organic solvent. The electrolyte may further include additives for improving charging/discharging characteristics and/or preventing over-charge.

The lithium salt may function as a lithium ion source in the battery to allow the lithium battery to operate. The nonaqueous organic solvent may function as a medium allowing ions associated with electrochemical reactions of battery to move.

Examples of the lithium salt may include one or more materials selected from the group of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl and LiI, and the lithium salt may be used alone or in mixture. A concentration of the lithium salt in the electrolyte may be about 0.6 to about 2.0 M, e.g., about 0.7 to about 1.6 M. Maintaining the concentration of the lithium salt at about 0.6 M or greater may help ensure sufficient electric conductivity of the electrolyte, thereby ensuring good electrolyte performance. Maintaining the concentration of the lithium salt at about 2.0 M or less may help prevent an increase in the viscosity of the electrolyte, thereby ensuring sufficient mobility of lithium ions.

Carbonate, ester, ether, or ketone may be used alone or in mixture as the nonaqueous organic solvent. Examples of the carbonate may include dimethyl carbonate (DMC), diethyl carbonate (DEC), dipropyl carbonate (DPC), methylpropyl carbonate (MPC), ethylpropyl carbonate (EPC), methylethyl carbonate (MEC) ethylene carbonate (EC), propylene carbonate (PC), and butylene carbonate (BC), examples of the ester may include γ-butyrolactone (GBL), n-methylacetate, n-ethyl acetate, and n-propyl acetate, and examples of the ether may include dibutyl ether.

In an implementation, a carbonate-based solvent may be used in mixture of a cyclic carbonate and chain-type carbonate. For example, the cyclic carbonate and the chain-type carbonate may be mixed in a volume ratio of about 1:1 to about 1:9. When the cyclic carbonate and the chain-type carbonate are mixed in the volume ratio stated above, desired electrolyte performance may be demonstrated.

In an implementation, the nonaqueous organic solvent may further include an aromatic hydrocarbon based organic solvent. Examples of the aromatic hydrocarbon based organic solvent may include benzene, fluorobenzene, bromobenzene, chlorobenzene, cyclohexylbenzene, isopropylbenzene, n-butylbenzene, octylbenzene, toluene, xylene, and mesitylene, which may be used alone or in mixture.

In the electrolyte including the aromatic hydrocarbon based organic solvent, the carbonate solvent and the aromatic hydrocarbon based organic solvent may be mixed in a volume ratio of about 1:1 to about 30:1. When the carbonate solvent and the aromatic hydrocarbon based organic solvent are mixed in the volume ratio stated above, desired electrolyte performance may be demonstrated.

The secondary battery including the electrode fabricated according to an embodiment will now be described in detail.

FIG. 5 illustrates a schematic cross-sectional view of a lithium secondary battery for a high voltage according to an embodiment.

Referring to FIG. 5, the lithium secondary battery according to an embodiment will be described with regard to a coin type lithium secondary battery, which is also referred to as a coin cell. The coin type lithium secondary battery may be manufactured by sequentially stacking an electrode (including a current collector 12 and an electrode material 13), a separator 14, another electrode (including an electrode material 13 and a current collector 12) in a metal housing 11 made of, e.g., stainless steel, impregnating an electrolyte solution into the resultant structure, and sealing a metal cover 15 and a gasket 16.

The secondary battery according to an embodiment may be manufactured in various shapes, including a prismatic battery, a cylindrical battery, and a pouch-type battery, in addition to the coin type battery illustrated herein.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Comparative Example 1

### Fabrication of Battery

20 g of LiNi_{0.5}Mn_{1.5}O₄ having a particle size of 10 μm as an active material, 0.64 g of Denka Black as a carbon-based conducting agent, and 10.64 g of polyvinylidenefluoride (fluorine-based resin commercially available in the trade name of Solef 6020, 6% binder solution) as a binder were mixed in a ratio of 94:3:3. The mixture was dispersed in N-methyl-2-pyrrolidone (NMP), thereby preparing a positive electrode slurry. The positive electrode slurry was cast on an aluminum thin plate (15 μm), dried in a vacuum oven maintained at a temperature of 120° C. and rolled, thereby fabricating a positive electrode. A negative electrode was fabricated using a negative active material (graphite, MAGV4) coated on a copper (Cu, 8 μm) plate, an electrolyte solution (1.15 M LiPF₆ in EC/EMC=3/7), and a separator (Asahi A1, 18 μm), thereby fabricating a 2016 coin-type full-cell battery.

### Example 1

A lithium secondary battery was fabricated in substantially the same manner as in Comparative Example, except that a mixture of 1.15 M LiPF₆ in EC/EMC=3/7 along with 0.01 wt % additive (Cyclene) was used as an electrolyte solution.

### Examples 2-3

A lithium secondary battery was fabricated in substantially the same manner as in Example 1, except that the additive was included in varying amounts, as shown in Table 1.

TABLE 1

| Additive (wt %) | Example 2 | Example 3 |
|---|---|---|
| Cyclene | 0.05 | 1 |

### Experimental Example 1

### Evaluation of Battery Performance

Charge and discharge tests were performed on the coin type secondary batteries manufactured in the Examples and Comparative Example. First, formation charge/discharge were performed twice with 0.1 C/0.1 C, and then charge/discharge were performed once with standard charge/discharge current density of 0.2 C/0.2 C, a charge cut-off voltage of 4.8V (Li/graphite), and a discharge cut-off voltage of 3.0 V (Li/graphite).

The secondary batteries manufactured in the Examples and Comparative Example were charged with a constant current of 0.5 C to then be stored in a constant-temperature chamber maintained at a high temperature of 60° C. Then, the OCV of each battery was measured. The measurement results are shown in FIG. 3. The OCV was measured using a battery tester (trade name: Hioki 3555 Battey HiTester). In particular, the batteries were stored at 60° C., taken out of the chamber at a time interval of 24 hours and then allowed to stand for 2 minutes, and the OCV of each battery was measured. While the battery manufactured in Comparative Example 1 showed a sharp voltage drop in OCV after 9 days at high-temperature storage, the batteries manufactured in Examples 1 and 2 did not show sharp voltage drops in OCVs until after 11 days at high-temperature storage.

### Experimental Example 2

### Evaluation of Battery Performance

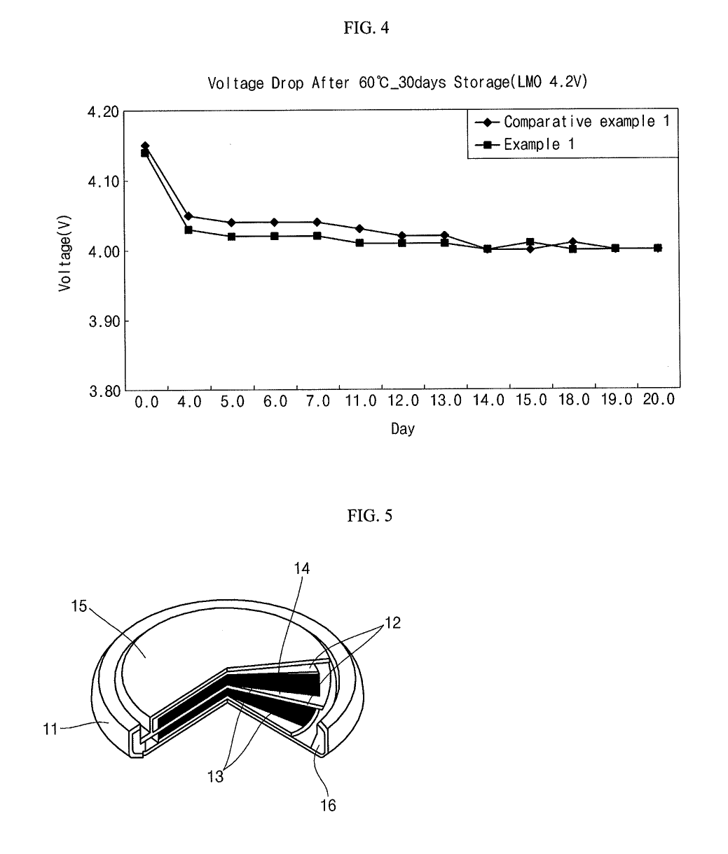

Battery performance was evaluated in substantially the same manner as in Experimental Example 1, except that the charge cut-off voltage was 4.2 V (Li/Li⁺). The measurement results are shown in FIG. 4. With the charge cut-off voltage of 4.2 V, the batteries showed no sharp voltage drop in the OCV, irrespective of use or non-use of additives.

As shown in FIGS. 3 and 4, in the 4.2V battery system, a significant difference was not made irrespective of use or non-use of the additive according to an embodiment. However, in the high voltage (4.8 V) battery system, the secondary battery including a cyclic polyamine compound according to the embodiments exhibited excellent high-temperature lifetime characteristic.

In the battery manufactured using the positive electrode slurry or composition including the inorganic additive according to an embodiment, a considerable drop of capacity, which may otherwise occur with addition of other additives, was not observed.

As described above, the inorganic additive according to an embodiment may help improve a manufacturing process of the positive electrode without adversely affecting battery performance. Thus, it may be advantageously used in manufacturing large-capacity batteries.

By way of summation and review, in view of energy density, high voltage may be difficult to attain using LiCo₂. Therefore, new materials capable of replacing LiCo₂ may be desirable. One such material may include Mn-based lithium oxide. However, when a spinel-type cell using 4V- or 5V-grade spinel-type Mn-based lithium oxide is stored at a high temperature, an electrolyte including a lithium salt, e.g., LiPF₆, may be decomposed to generate HF, resulting in elution of metal ions. In addition, due to precipitation of the eluted metal ions on a surface of a negative electrode, a potential of the negative electrode may rise, and an open-circuit voltage (OCV) of a cell may be lowered, thereby deteriorating cycle performance and high-temperature storage characteristics.

The embodiments provide a lithium secondary battery for producing a high voltage, which includes a ring-type or cyclic polyamine as an additive to help reduce the likelihood of and/or prevent manganese from being eluted from a manganese based positive electrode, thereby improving a high-temperature storage characteristic of the lithium secondary battery.

The embodiments provide a lithium secondary battery for producing a high voltage, which exhibits improved cycle performance and high-temperature storage characteristics while achieving the high voltage.

According to an embodiment, precipitation of eluted Mn ions to a negative electrode may be be suppressed by a cyclic amine compound used as an additive, thereby improving the high-temperature storage characteristic of a battery system using a positive active material for a high voltage.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A lithium secondary battery for producing a high voltage, the lithium secondary battery comprising:
a negative electrode;
a cyclic polyamine compound as an additive; and
a positive electrode including a high-voltage spinel-type positive active material represented by Formula 1:
Li₁₊ₓNi_{y}Mn_{2-y-z}M_{z}O_{4+w} (1)
wherein, in Formula 1, 0≦x<0.2, 0.4≦y≦0.6, 0≦z≦0.2, 0≦w≦0.1, and M is at least one element selected from the group of Al, Ti, Mg, Zn, Mo, Y, Zr and Ca.

2. The lithium secondary battery as claimed in claim 1, wherein the cyclic polyamine compound includes at least one selected from the group of 1,4,8,11-tetraazacyclotetradecane (cyclam), 1,4,7,10-tetraazacyclododecane (cyclene), 1,4,8,11-tetramethyl-1,4,8,11-tetraazacyclotetradecane (TM-cyclam), 1,4,8,11-tetraazacyclotetradecane-5,7-dione (DO-cyclam), and cyclo(β-alanylglycyl-β-alanylglycyl).

3. The lithium secondary battery as claimed in claim 1, wherein the cyclic polyamine compound is in an electrolyte solution.

4. The lithium secondary battery as claimed in claim 3, wherein the cyclic polyamine compound is included in an amount of about 0.01 wt % to about 1 wt %, based on a total weight of the electrolyte solution.

5. The lithium secondary battery as claimed in claim 1, wherein the positive electrode further includes one or more inorganic additive selected from the group of ZnO, TiO₂, SnO₂, Al₂O₃, In₂O₃, SiO₂, WO₃, and V₂O₅.

6. The lithium secondary battery as claimed in claim 1, wherein an operating voltage of the positive electrode is about 4.6 V or higher, based on lithium metal.

7. The lithium secondary battery as claimed in claim 1, wherein the compound represented by Formula 1 is LiMn_{1.5}Ni_{0.5}O₄.

8. The lithium secondary battery as claimed in claim 1, wherein the cyclic polyamine compound includes 3 or more nitrogen atoms in a ring of the compound.

9. The lithium secondary battery as claimed in claim 8, wherein the cyclic polyamine compound includes 4 to 8 nitrogen atoms in the ring of the compound.

10. The lithium secondary battery as claimed in claim 8, wherein the polyamine compound further includes at least one pendant hydrocarbon group bound to at least one of the nitrogen atoms in the ring of the compound.
